(19) United States
(12) Patent Application Publication
(10) Pub. No.: US 2021/0130176 A1
(43) Pub. Date: May 6, 2021

(54) Multimodal Particles for Retention and Drainage for Paper-Making Machines

(71) Applicant: Applied Material Solutions, Inc., Elkhorn, WI (US)

(72) Inventors: Thomas Rebernak, Elkhorn, WI (US); Robert Ellis Wilson, Elkhorn, WI (US); Michael Timothy Jennings, Williams Bay, WI (US)

(73) Assignee: Applied Material Solutions, Inc., Elkhorn, WI (US)

(21) Appl. No.: 17/063,010

(22) Filed: Oct. 5, 2020

Related U.S. Application Data
(63) Continuation-in-part of application No. 16/155,067, filed on Oct. 9, 2018.
(60) Provisional application No. 62/570,728, filed on Oct. 11, 2017.

(51) Int. Cl. C01B 33/143; D21F 1/66; D21F 1/10

(52) U.S. Cl. CPC C01B 33/1435; D21F 1/66; B82Y 30/00; C01P 2004/64; C01P 2006/12; D21F 1/10

(57) ABSTRACT

A colloidal silica solution which includes two or more colloidal silica compositions or suspensions having differing particle sizes and specific surface areas, the compositions or suspensions resulting in a multimodal particle size distribution in which the solution or suspension can be bimodal in nature and composed of, but not limited to, particles with a mode of 4 nm and 20 nm or composed of particles 7 nm and 12 nm. The solution or suspension can also be trimodal and composed of, but not limited to, 4 nm, 7 nm and 15 nm or 3 nm, 5 nm, and 20 nm. The solution or suspension can also include other multimodal systems which would give superior water drainage and fiber and ash retention on paper machines. The colloidal silica solution is a drainage and retention aid in the making of paper.

### RELATED APPLICATION

This application claims priority to Provisional Patent Application Ser. No. 62/570,728, filed Oct. 11, 2017, and to patent application Ser. No. 16/155,067, filed Oct. 9, 2018, the entire contents of which are incorporated herein.

### FIELD OF THE INVENTION

The field is related generally to chemical compounds, and more particularly, to a chemical compound and method for enhanced drainage of water and retention of fine particles in the paper making industry.

### BACKGROUND OF THE INVENTION

Colloidal silica has been used in paper making as a retention and drainage aid in paper making since the 1980's. Colloidal silica is typically run with starch, acrylamide or acrylic polymers, in conjunction with monomodal colloidal silicas. Particle size is normally determined from surface area titrations and is monomodal in nature, centered around 4-5 nm in size.

Drainage aids on paper machines have long been a focus in the paper making industry. The use of chemistries to enhance drainage and retention on paper machines has included cationic starch, polyacrylic acid derivatives, alum and colloidal silica. With the use of colloidal silica there was a noticeable increase in retention and drainage when using the other chemistries previously mentioned. The colloidal silicas used in the past and present are all monomodal in nature.

The manufacturing of colloidal silica for paper machine retention and drainage aids employs the use of a colloidal silica made to a specific particle size, more specifically made to a particular Specific Surface Area (SSA) or particle size which sometimes is calculated from the SSA and other times measured directly by Diffraction Light Scattering (DLS).

In the paper making process, it has been historically difficult to improve the retention and drainage on the forming wire. The invention disclosed herein can be applied to the formation of the fiber mat in paper manufacturing and yields improved properties regarding retention and drainage on the forming wire.

In the paper making process an aqueous slurry containing cellulose fiber and various optional fillers and additives, commonly referred to as stock, is fed into a headbox and through the headbox distributed onto a formation wire. In the process the water drains from the sheet through the wire, forming the paper sheet. The sheet is further dewatered in the drying section of the paper machine. In order to increase the drainage of water and retention of the fines (small cellulose fiber and inorganic fillers) during the formation of the sheet, drainage and retention aids are often used. The drainage aid is also the retention aid.

Silica particles are used with other additives to help retain the small fines and fillers along with the drainage of water from the sheet of newly forming paper. The colloidal silica typically ranges in size from 3 nm to 8 nm in a monomodal distribution.

Silicon dioxide (SiO₂) is one of the most common materials on the planet. The advantage of synthesized colloidal silica is controlled surface area and that it is purely amorphous, whereas natural colloidal silica is a mixture of amorphous and crystalline silicon dioxide. The advantage of amorphic silica is that it has a much higher surface area than crystalline silica.

Below is a brief overview of the steps in the formation of paper on the paper machine. (1) The stock is sprayed from the headbox on to the forming fabric called the fourdrinier, the fourdrinier is an endless moving fabric which forms the fibers into a continuous matted web, or sheet; (2) the fourdrinier drains the water away from the sheet by suction forces; (3) the paper sheet is conveyed through a series of presses where additional water is removed and the web structure is consolidated; (4) the remaining water is removed through evaporation in the dryer section; (5) fillers can be added at the headbox or prior to the head box; (6) as the water drains the fines, which include small fibers and fillers, will pass through the sheet as it is forming and remain in the paper machine water system; (7) a retention aid program using a polyacrylate polymer, cationic chemistry, and colloidal silica will form a floc with the fibers on the fourdrinier; (8) as the floc forms, water is moved away from the floc and allowed to drain from the newly forming sheet faster; and (8) the floc also attracts the fines, which would have previously flowed through the sheet.

The fines are now retained in the sheet and the charge of the colloidal silica helps to bring the zeta potential of the system to near zero. A zeta potential at or near zero gives the best retention of the fines. A benefit of greater retention is more water drains faster because of the flocculation on the fourdrinier, thus less water has to be removed in the press and dryer section of the paper machine.

### SUMMARY OF THE INVENTION

The present invention is a colloidal silica solution which is used as part of a drainage and retention aid program in the making of paper. The application discloses the use of a multimodal colloidal silica which can be used in conjunction with the polymeric retention aid products to improve both retention and drainage properties of paper matrices.

Highly preferred embodiments include a colloidal silica solution comprising two or more colloidal silica compositions or suspensions having (a) differing particle sizes; and (b) specific surface areas, the compositions or suspensions resulting in a multimodal particle size distribution in which the solution is bimodal and composed of, but not limited to, particles with a mode of 4 nm and 20 nm or composed of particles 7 nm and 12 nm; the solution is trimodal and composed of, but not limited to, 4 nm, 7 nm and 15 nm or 3 nm, 5 nm, and 20 nm; or the solution is comprised of other multimodal systems which have superior water drainage as well as fiber and ash retention on paper machines.

In preferred embodiments, the colloidal silica solution further can include a SiO₂ content of 6% to 50% as well as a mixture of individual colloidal silica solutions or suspensions ranging in particle sizes of between 3 nm to 100 nm. Preferably, the pH of the colloidal silica solution is between 8.0 and 10.5.

It is preferred that each of the solutions or suspensions when separate from each other have an individual mean Specific Surface Area of 1,000 m²/g to 30 m²/g and a particle size of 3 nm to 100 nm. Preferably, the solutions or suspensions of colloidal silica when combined together have a mean Specific Surface Area of 999 m²/g to 31 m²/g and a particle size of 3 nm to 100 nm. The size of the individual colloidal silica particles will not change when two or more sols of different sizes are mixed. The overall average specific surface area however is affected, since this is a mixture of small and large surface areas.

Methods of manufacture and use are within the scope of the invention.

### Definitions

“A” or “an” means one or more.

“About” means approximately or nearly, and in the context of a numerical value or range set forth herein, means±10% of the numerical value or range recited or claimed.

“Bimodal” means or refers to having or involving two modes.

“CPAM” means or refers to Cationic Poly-Acrylamide.

“Decant” means or refers to gently pouring a liquid so as not to disturb the sediment.

“Retention Aid” means or refers to a chemical program used to improve FPR and FPAR. The chemicals used form a floc on the formation wire which links the fines to the fibers which would not have been retained without a retention aid. A retention aid program usually includes a high molecular weight polyacrylate, cationic materials, and colloidal silica.

“Drainage Aid” means or refers to the same chemistry as used in the Retention Aid program. The improved drainage is a result of the floc being formed and dewatering the paper sheet during the formation. This happens at the same time the fines are being retained.

“EO” means or refers to ethylene oxide or ethoxylated compound.

“Fines” means or refers to small cellulose materials and inorganic filler which are small enough to pass through the formation wire.

“Filler” means or refers to inorganic clays such as titanium dioxide, magnesium silicate (talc), kaolin, and calcium carbonate.

“Floc” means or refers to a flocculant mass: a flocculant mass formed by the aggregation of a number of fine suspended particles—Merriam-Webster definition.

“Flocculant” means or refers to a substance which promotes the clumping of particles. Examples of uses are in treating waste water, in chemical recovery, and as paper machine retention and drainage aids—Merriam-Webster definition.

“FPR” means or refers to First Pass Retention.

“FPAR” means or refers to First Pass Ash Retention.

“Mode” means or refers to the most frequent value of a set of data.

“Molecular weight” means or refers to the average molecular weight of a polymer.

“Multimodal” means or refers to having or involving several modes.

“PAC” means or refers to Poly-Aluminim Chloride.

“PCC” means or refers to Precipitated Calcium Carbonate.

“Silica” means or refers to silicon dioxide.

“Silicate” means or refers to precipitated silica, fumed silica, diatomaceous earth, volcanic ash, talc, and other such compounds which are silicates and are referred to as such throughout the patent.

“Starch” means or refers to a cationic starch used in conjunction with drainage and retention aids.

“Trimodal” means or refers to having or involving three modes.

As used herein, the term “wt. %” means or refers to percent by weight.

“Zeta Potential” means or refers to a measurement used to characterize the electrical charges existing in fine dispersions, such as a pulp slurry used on the paper machine.

### BRIEF DESCRIPTION OF THE DRAWINGS

The application file contains at least one drawing executed in color. Copies of this patent application publication with color drawing(s) will be provided by the Office upon request and payment of the necessary fee.

The drawings illustrate a preferred embodiment including the above-noted characteristics and features of the invention. The invention will be readily understood from the descriptions and drawings. In the drawings:

FIG. 1 is a table illustrating the control sample of the present invention;

FIG. 2 is a table illustrating the composition of the samples tested;

FIG. 3 is a table illustrating the parts per sample including the number of modes and particle size of each part;

FIG. 4 is a table illustrating the drainage and retention evaluations run on each sample;

FIG. 5 is a graph illustrating an example of a monomodal sol;

FIG. 6 is a graph illustrating an example of a multimodal sol;

FIG. 7 shows tables illustrating the experiment design and sample information;

FIG. 8 shows tables illustrating testing results;

FIG. 9 is a graph illustrating testing results;

FIG. 10 is a graph illustrating testing results;

FIG. 11 is a schematic of a dynamic drainage analyzer;

FIG. 12 is a graph illustrating testing results;

FIG. 13 is a graph illustrating testing results; and

FIG. 14 is a graph illustrating testing results.

### DETAILED DESCRIPTION OF THE INVENTION

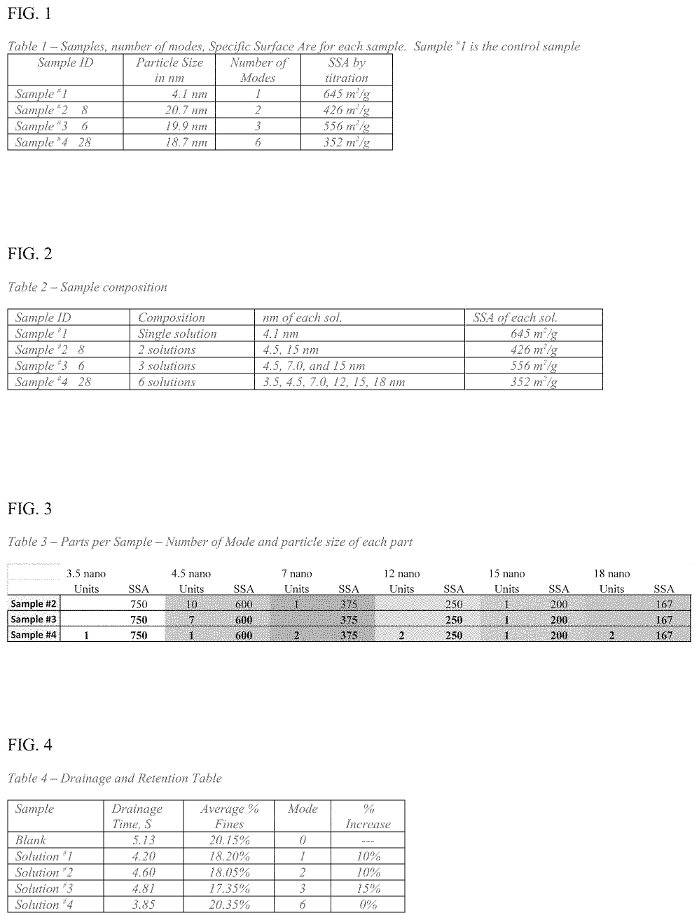

As seen in FIGS. 1-14 and the disclosure herein, the colloidal silicas relating to this invention are produced by stripping sodium water glass, also known as sodium silicate or silicate soda, using a high acid ion exchange resin. The sodium silicate is converted to a loose version of silicic acid. The silicic acid is run through the reactor under specific conditions (temperature, flow rates, pH and concentrations) to nucleate particles <5 nm.

Once seeds are formed, silicic acid is fed at varying rates to push the reaction toward accretion as opposed to nucleation (typically by controlling temperature and flow rate/concentration). The particle is grown to the desired size needed.

The raw product is then allowed to ripen (using Ostwald ripening effects) for a brief period of time. The concentration is typically 6-8% solids by weight. Once ripened and at an appropriate temperature, raw colloidal silica can be run through ultra-filtration to de-water the product. Therefore colloidal silica at 6-8% solids can be concentrated up to 50%.

Final concentration is limited by particle size, time, and economics. Smaller particles become more unstable as concentration rises. As concentration passes the threshold limitations it begins to agglomerate. During this period there is a high risk of gel formation. The water removal process involved is not a linear process but is asymptotical. Once the final concentration is achieved the material is transferred to a finishing tank. The multimodal systems for this invention are built by blending discrete monomodal standard products to build the desired specific surface area and particle size distribution.

In the present application, a colloidal silica based (SiO2) system comprised of two or more particle sizes provides better drainage and fines retention on the formation wire of the paper machine. The manufacturing of colloidal silica for paper machine retention and drainage aid employs the use of a colloidal silica made to a specific particle size. More specifically, it is made to a stated particular SSA (Specific Surface Area) or particle size, sometimes calculated from the SSA or alternatively calculated by measuring DLS (Diffraction Light Scattering). In the present application, a multimodal colloidal silica system used in conjunction with the polymeric retention aid products, such as polyacrylamide, polyacrylates, and other cationic chemistry, improves both retention and drainage properties of the paper matrices.

The present application discloses that a multimodal colloidal dispersion would allow for a more efficient colloidal silica design for the retention aid program than a standard single particle size program. The present application discloses the mixing of various sized colloidal silica particles to impact drainage and retention, allowing for a targeted design of a colloidal silica package for a given paper machine application and suppling the best economics for retention and drainage. Too much retention adversely affects drainage and, conversely, too much drainage will adversely affect retention. With a multimodal system both retention and drainage can be balanced to suit the needs of the customer.

In the present application four samples were prepared. Particle size was measured using Diffraction Light Scattering. The sample measurements can be seen in FIGS. 1-4. FIG. 1 illustrates Table 1 which was the control sample. FIG. 2 or Table 2 illustrates the composition of samples tested. FIG. 3 or Table 3 illustrates the parts per sample including the number of modes and particle size of each part. FIG. 4 or Table 4 illustrates the drainage and retention evaluations run on each sample.

The results in FIGS. 1-4 illustrate that the drainage was faster on all samples over the Blank. FIGS. 1-4 also illustrate that the drainage appeared to get slower as the number of different particle sizes were increased. This result could be a function of average particle size and SSA as it is the number of modes. The retention of fines increased as the modality of the samples increased until there were six different modes in sample ^{#}4.

With the decrease in drainage time and the lack of fiber retention it is evident that the number of modes and the quantity of larger particles will play a large role in how well the final product works.

FIGS. 1-4 disclose a colloidal silica solution having two or more colloidal silica compositions or suspensions with differing particle sizes and specific surface areas. The compositions or suspensions result in a multimodal particle size distribution in which the solution is bimodal and composed of, but not limited to, particles with a mode of 4 nm and 20 nm or composed of particles 7 nm and 12 nm; the solution being trimodal and composed of, but not limited to, 4 nm, 7 nm and 15 nm or 3 nm, 5 nm, and 20 nm; or the solution comprised of other multimodal systems which have superior water drainage as well as fiber and ash retention on paper machines. The colloidal silica solution is a drainage and retention aid in the making of paper.

The colloidal silica solution includes a SiO₂ content of 6% to 50% as well as a mixture of individual colloidal silica solutions or suspensions ranging in particle sizes of between 3 nm to 100 nm. The pH of the colloidal silica solution is between 8.0 and 10.5.

The solutions or suspensions when separate have an individual mean Specific Surface Area of 1,000 m²/g to 30 m²/g and a particle size of 3 nm to 100 nm. The solutions or suspensions of colloidal silica when combined together have a mean Specific Surface Area of 999 m²/g to 31 m²/g and a particle size of 3 nm to 100 nm. FIGS. 1-4 illustrate that the particle size distribution of the mixed sols allows the colloidal silica sol mixtures to have an impact on the retention and drainage of the experimental system by affecting the overall charge of the system. Affecting the charge of the system will impact the floc being formed on the formation wire. The floc will determine the percent of retention and the drainage rate.

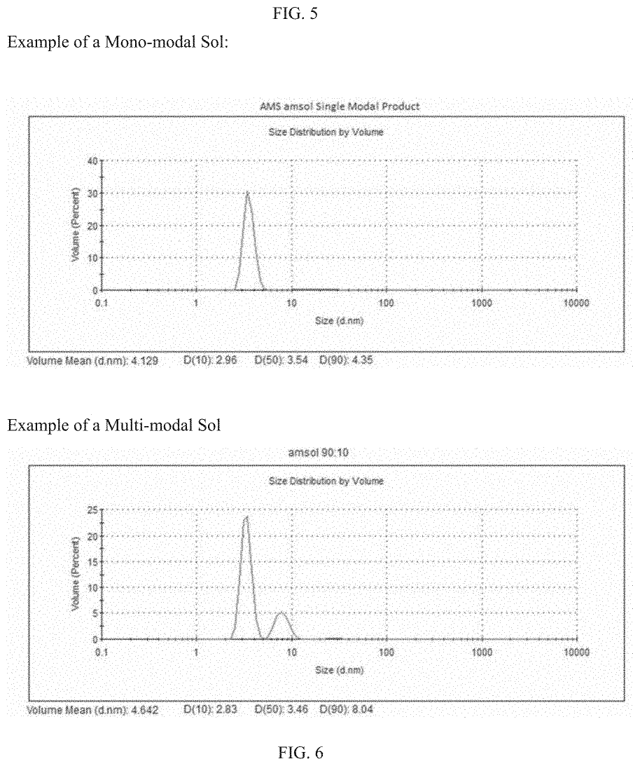

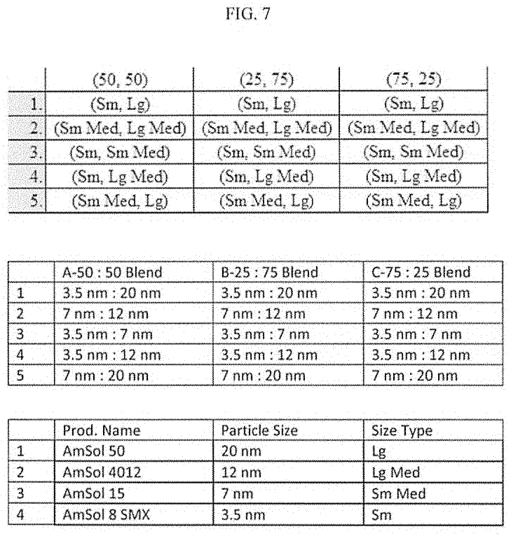

FIG. 5 illustrates an example of a monomodal sol whereas FIG. 6 illustrates an example of a multimodal sol. The differences between a mono versus a multimodal sol can be seen in FIGS. 5 and 6.

FIG. 7 consists of three charts. The first chart (top of FIG. 7) illustrates how the experiment was designed. The second and third charts (middle and bottom charts on FIG. 7) illustrate how the experiment samples were prepared. Each sample was labeled with the product name which is commercially available from the applicant (this includes AmSol 50, Amsol 4012, AmSol 15 and AmSol 8 SMX) or alternatively labeled with the control name with lot number. Blended samples which were used in the experiment have lot numbers based on the date of manufacture. Samples which were sent out for testing are labeled A1, A2, A3, A4 and A5 and the same labeling format was also used for the B and C samples.

The relevant experiments in the present application were performed using a Britt Jar Test and the testing was performed in the following manner. Three pulp fiber samples were used as a stock slurry in the test: bleached ground wood pulp, bleached soft wood kraft pulp and bleached hardwood kraft pulp. The pulp samples were each tested for fiber content. The solid content for the bleached hardwood kraft was 3.21% and for both the bleached softwood kraft and ground wood it was 3.45%.

The stock fiber suspension for the testing was prepared by mixing 60% hardwood kraft, 20% softwood kraft and 20% ground wood. The stock fiber suspension was added with a desired amount of Precipitate Calcium Carbonate (“PCC”) so that the final stock slurry contained 25% PCC (as received) and 75% stock fiber suspension.

The stock slurry was added with 15 lb/ton of newly prepared starch solution (dry starch/dry ton of fibers) under stirring. This was followed by the addition of PAC in the amount of 4 lb/ton of fibers. The mixture was diluted to contain 0.7% fibers. 70 g diluted slurry aliquot (accurate to 0.1 g) was weighed into a beaker. After the Britt Jar was set up, the slurry was poured into the jar. 430 g water was used to rinse all the content into the jar. The final fiber suspension in the jar was 500 g. When stirring at 1000 rpm had run for 10 seconds, CPAM in the amount of 1 lb per ton of fibers was added; after another 10 seconds a desired amount of diluted silica sample was added, and after another 10 seconds had passed the drainage of the jar was open.

Around 80 to 100 g filtrate was collected within a period of 30 seconds. The filtrate was filtered through a weighted Whatman ashless filter paper. The dry weight of the fines was determined after overnight drying in a 105° C. oven. The fines were then ashed under 525° C. for five hours.

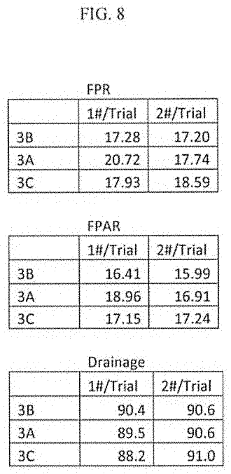

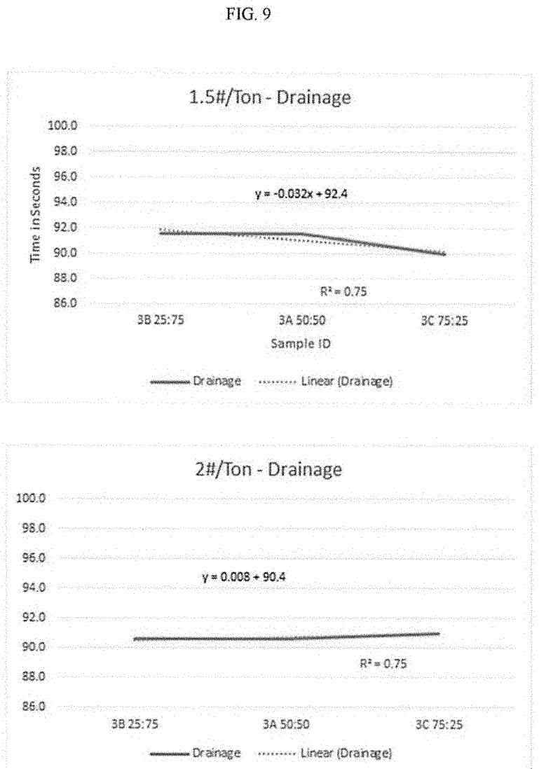

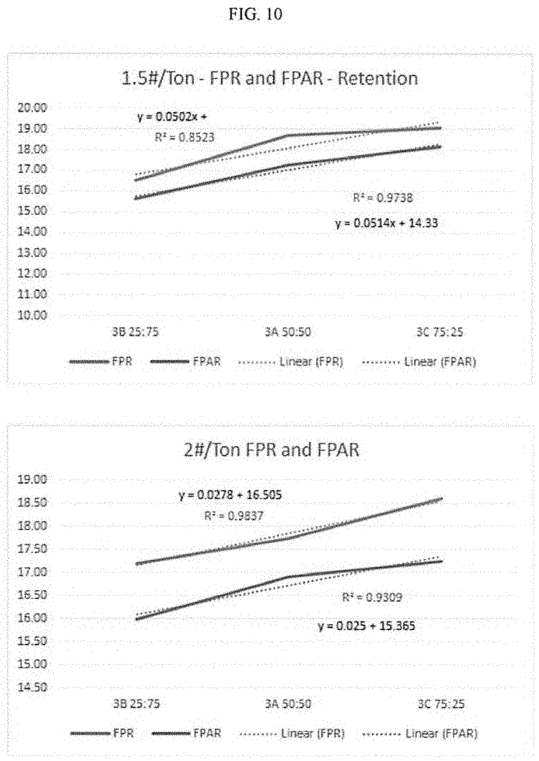

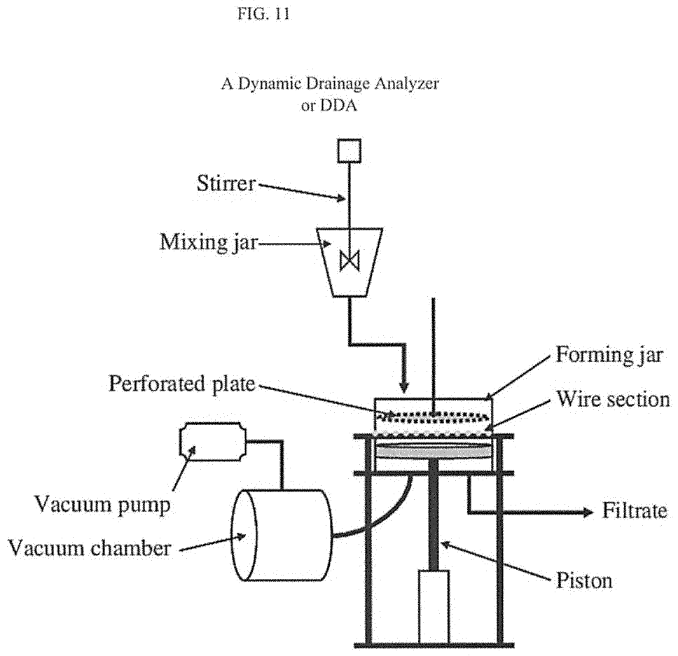

The results showed various effects on Retention and Drainage, but the results of Sample 3A, 3B, and 3C were very linear and indicated strongly that the particle ratio to optimize Drainage and Retention could be predicted. The Results for 3A, 3B, and 3C are seen in FIG. 8. FIGS. 9-10 were also generated based on the results of the above-noted experiment.

Additional experiments were done using a Dynamic Drainage Analyzer (see FIG. 11) to measure the rate of water flow through a screen. A vacuum was applied to the chamber receiving the water. The water was allowed to flow into the chamber and data points were collected at a rate of 1 data point per second to 5 data points per second depending on the model. The amount of time it took to drain a given amount of water was measured in seconds. A schematic of a Dynamic Drainage Analyzer is shown in FIG. 11.

The following testing protocol was used to make the pulp slurry for the testing in the Dynamic Drainage Analyzer: 60% of hardwood (short fiber); 20% softwood (long fiber) and 20% ground wood or Thermomechanical Pulping. 25% of PCC filler was also added. The thick stock additives consisted of starch at 15 lb/ton and PAC at 4 lb/ton. The thin stock consistency was 0.70% and thin stock additives consisted of CPAM and silica (dry solids 2.0 lb/ton).

The timing sequence used for the vacuum drainage on the Dynamic Drainage Analyzer is below:

Sequence: 1000 rpm, 30 sec.

T=0 sec: Start Sequence

T=10 sec: Add CPAM

T=20 sec: Add Silica

T=30 sec: Start register pressure vs time

The timing sequence used for the dynamic drainage jar (Britt Jar) for First Pass and Ash Retention is below:

Sequence: 1000 rpm, 30 sec.

T=0 sec: Start Sequence

T=10 sec: Add CPAM

T=20 sec: Add Silica

T=30 sec: Recovery of Filtrate through “Syracuse 125 P” Screen (White Waters)

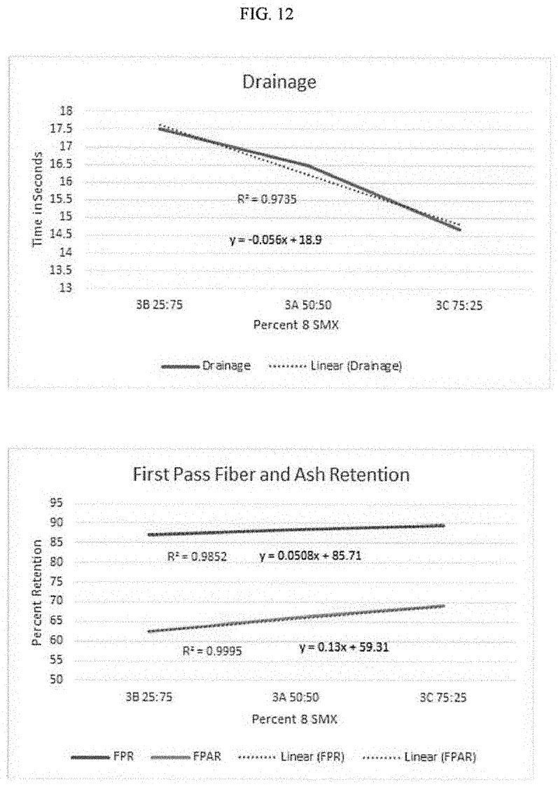

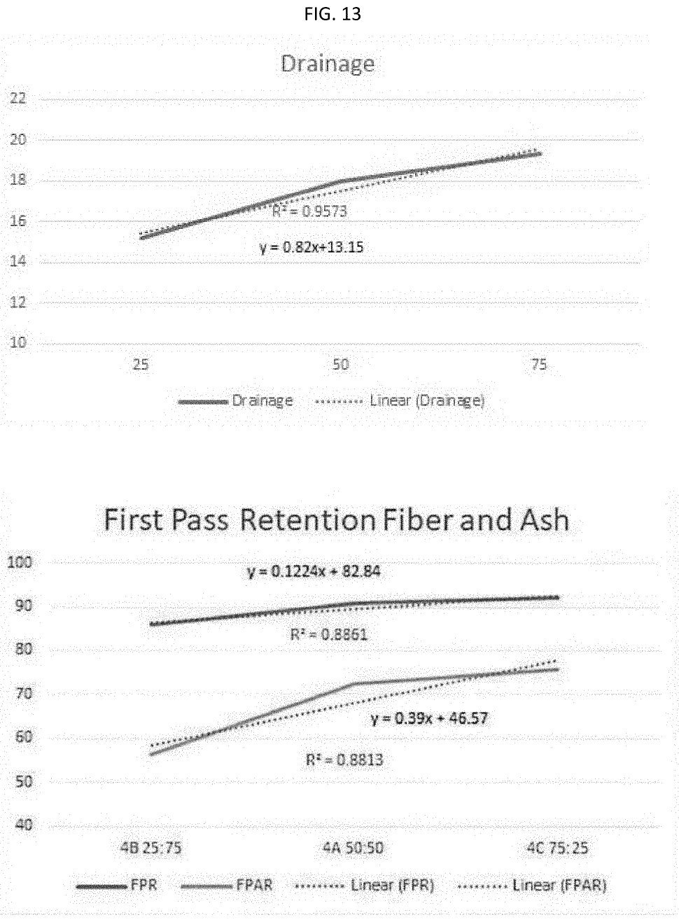

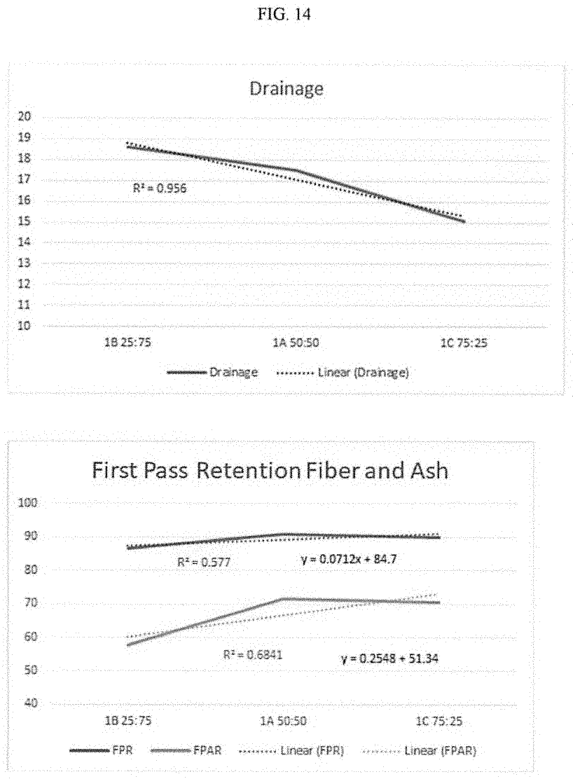

The pulp capture was weighed out for the percent retention then ashed for the first pass retention in a similar manner as was done with the Britt Jar testing. The results can be seen in the graphs in FIGS. 12-14. FIG. 13 illustrates the results of samples 1A, 1B and 1C. FIG. 14 illustrates that 1A through 1C show that the linear correlation decreases with some silica mixtures.

Overall, FIGS. 12-14 show that mixing particles of different sizes will impact the drainage, the First Pass Retention and the First Pass Ash Retention. Once a line is calculated it becomes possible to then calculate the proper mixture of particles necessary to have the desired drainage and retention as noted and claimed in this application.

Wide varieties of materials are available for the various parts discussed and illustrated herein. While the principles of this invention and related method have been described in connection with specific embodiments, it should be understood clearly that these descriptions are made only by way of example and are not intended to limit the scope of the application. It is believed that the invention has been described in such detail as to enable those skilled in the art to understand the same and it will be appreciated that variations may be made without departing from the spirit and scope of the invention.

1. A colloidal silica solution comprising two or more colloidal silica compositions or suspensions having: (a) differing particle sizes; and (b) specific surface areas, the compositions or suspensions resulting in a multimodal particle size distribution wherein:
the solution being bimodal and composed of, but not limited to particles with a mode of 4 nm and 20 nm or composed of particles 7 nm and 12 nm;
the solution being trimodal and composed of, but not limited to, 4 nm, 7 nm and 15 nm or 3 nm, 5 nm, and 20 nm; or
the solution comprised of other multimodal systems which have superior water drainage as well as fiber and ash retention on paper machines,
whereby the colloidal silica solution is used in a drainage and retention aid program in the making of paper.

2. The colloidal silica solution of claim 1 further including a SiO₂ content of 6% to 50%.

3. The colloidal silica solution of claim 1 further including a mixture of individual colloidal silica solutions or suspensions ranging in particle sizes of between 3 nm to 100 nm.

4. The colloidal silica solution of claim 1 wherein the pH of the colloidal silica solution is between 8.0 and 10.5.

5. The colloidal silica solution of claim 1 wherein each of the solutions or suspensions when separate have an individual mean Specific Surface Area of 1,000 m²/g to 30 m²/g and a particle size of 3 nm to 100 nm.

6. The colloidal silica solution of claim 1 wherein the solutions or suspensions of colloidal silica when combined together have a mean Specific Surface Area of 999 m²/g to 31 m²/g and a particle size of 3 nm to 100 nm.

7. The colloidal silica solution of claim 1 wherein the use of various colloidal silica solutions or suspensions with varying discrete particle sizes allows for increased fiber and ash retention and water drainage by providing better floc formation during the formation of the paper sheet on the fourdrinier.

8. The colloidal silica solution of claim 7 wherein the floc allows for faster and more even drainage of water from a fiber mat as well as increased fiber and ash retention in the fiber mat and a more even distribution of fiber and ash across the paper sheet.
